(19) United States
(12) Patent Application Publication
(10) Pub. No.: US 2009/0266362 A1
(43) Pub. Date: Oct. 29, 2009

(54) Rapid Production of Customized Masks

(76) Inventor: Phillip E. Mark, Orlando, FL (US)

Correspondence Address: Timothy H. Van Dyke;Beusse Wolter Sanks Mora & Maire, P.A., Suite 2500, 390 North Orange Avenue, Orlando, FL, 32801, US

(21) Appl. No.: 12/108,139

(22) Filed: Apr. 23, 2008

(51) Int. Cl. A62B 18/02; G06K 9/00

(52) U.S. Cl. 128/205.25; 382/154

(57) ABSTRACT

Disclosed herein is a system designed for the rapid preparation of anatomically customized mask employing data from a patient. The data may take the form of a multidimensional image of a target area of a patient's face obtained by optical 3 dimensional imaging, or a dot or line scan form laser imaging, pattern laser photography or stereo photography. Also disclosed is a mask that is designed so as to be unobtrusive and comfortable for the user. The body of the mask is made of a thin layer, so it is lightweight and closely hugs the targeted region upon which it rests (e.g. the nasal region). Methods for producing anatomically customized masks are also described.

### BACKGROUND

Obstructive sleep apnea (OSA) and other sleep-related respiratory disorders are debilitating conditions that, if left untreated, can result in dramatic health consequences. Obstructive sleep apnea is characterized by instability of the upper airway occurring during sleep and leads to frequent episodes of breathing cessation (apnea) or decreased airflow (hypopnea). During these episodes, the patient has a brief arousal from sleep that allows restoration of airway patency and resumption of breathing. The segmentation of sleep derived from these episodes of “nocturnal asphyxia”, which can occur as much as 400-500 times per night, leads to excessive daytime somnolence and narcolepsy. Hypersomnolence can become disabling and dangerous; studies show that patients with OSA have two to seven times more motor vehicle accidents than people without OSA. In addition, these episodes can also cause intellectual impairment, memory loss, personality disturbances, impotence, arrhythmias, hypertension, heart attacks, stroke, and premature death. Surgical and non-surgical therapies have been developed for alleviating the symptoms of sleep apnea, or even curing sleep apnea. While surgery may make sense in extreme cases, the surgery can be expensive, and painful, and the surgical outcomes are not always positive. The most common non-surgical therapy for sleep apnea is continuous positive airway pressure (CPAP). One problem that the inventor has now realized with respect to CPAP is that the equipment used is uncomfortable, which affects the ability to sleep. In addition, CPAP masks and equipment are unsightly, which has a negative psychological result concerning one's own well-being.

### BRIEF DESCRIPTION OF THE DRAWINGS

FIGS. 1a-d show a diagram showing a system embodiment of the invention;

FIG. 2 shows an image of a point cloud useful with an embodiment of the present invention;

FIG. 3 shows a stereo_lithograph image useful with an embodiment of the invention;

FIG. 4 shows a stereo_lithograph image useful with an embodiment of the invention;

FIG. 5 shows an image depicting regions of the face that are scanned according to an embodiment of the invention

FIGS. 6 a-e show a pictorial flow diagram of a method of the invention; and

FIG. 7 shows an image depicting imaging of a face according to an embodiment of the invention.

### DETAILED DESCRIPTION

The inventor has realized that while some efforts have been made to improve the comfort of conventional CPAP masks by providing a number of different sizes, comfort levels still fall short. The invention is based on the inventor's discovery that the comfort level of CPAP masks has a dramatic effect on the compliance and effectiveness of CPAP for treating OSA. In one embodiment, the invention pertains to the rapid production of masks used in conjunction with CPAP that are customized to a particular region of a patient's face. The methods of making customized masks and the configuration of mask embodiments disclosed herein dramatically improves the comfort level of masks.

In one embodiment, the invention is directed to a system designed for the rapid preparation of anatomically customized mask employing data from a patient. The data may take the form of a multidimensional image of a target area of a patient's face obtained by optical 3 dimensional imaging, or a dot or line scan form laser imaging, pattern laser photography or stereo photography.

The data is typically acquired at a first site, while engineering and/or manufacturing services and equipment are located at a second site, remote with respect to the first site. Transmittal of a patient's data over telecommunication or computer networks can significantly reduce the time required for production and manufacture of masks.

For processes using a mold to produce the mask, such as through vacuforming techniques, the mold is formed to provide certain adjustments to the configuration of the mask to improve comfort and fit of the mask. For example, the mold is made to have a protruding surface (or raised geometry) such that a plenum between the inner surface of the mask and a portion of the target region is formed. This could be accomplished, for example, by adjusting the scanned image to generate a protruding surface that extends from the natural contour of a portion or the entire target region. In a specific embodiment, the protruding surface may extend between 0.1-1.0 inches off of the natural contoured surface of the target region. In a more specific embodiment, the protruding surface extends between 0.15-0.4 inches off the natural contoured surface of the target region. In an even more specific embodiment, the protruding surface extends about 0.25 inches off the natural contoured surface of the target region. A layer of plastic or the like, is vacuformed over the mold, removed from the mold and cut. A silicon or thermoplastic ring is made to fit the outer edge of the mask. This ring will be in contact directly with the patient's face and will allow a wide range of facial movement, while still retaining the seal.

In one embodiment, an image is produced from the dataset, which in turn is used to produce a mold of the target region. The mold is then used to produce a mask specifically tailored and customized to cover the target region of the patient, from which data was obtained. In one embodiment, the mold is formed using a computer numerical control (CNC) machine that forms the mold based on the dataset.

In certain embodiments, the mask is imprinted or engraved with the patient's name and a serial no. is assigned to the mask. The serial no. is catalogued and stored in a database such that additional masks may be reordered for the patient. Also, the mask may engrave or imprinted with marketing information such as trademarks or logos of suppliers. In this sense, the mask also serves as potential marketing and promotional function.

One advantageous feature of the mask is that it is designed so as to be unobtrusive for the user. The body of the mask is made of a thin layer, so it is lightweight and closely hugs the targeted region upon which it rests (e.g. the nasal region). In a specific embodiment, the thin layer material is 3/32 inches to ⅛ inches in thickness. In another specific embodiment, the mask is lightweight, between 15 to 45 grams. Also, the mask is configured to key on the nasal bridge and follows the contours of the nasal bridge so as to minimize cantilevering of the mask at the nasal bridge. Thus, if pressure is applied to either the left or right sides of the mask, the mask does not lift off the nasal bridge. In addition to having the portion of the mask closely simulate the geometry of the nasal ridge, the mask also closely simulates the patient's upper lip just under the patient's nares. In addition, the lower portion of the sides of the mask (about the lower quarter portion) closely simulate the geometry of the patient's face. Thus, the nasal ridge portion of the mask, the lower side portions, and the bottom portion under the nose form a four-point contact that stabilizes the mask on the patient's face. As pointed out above, the rest of the nose does not contact the mask, thereby allowing the nose to flare without touching the inner walls of the mask. Also, the plenum between the inner wall of the mask and the patient's nasal surface allows the nasal surface to be cooled by air in the mask, which avoids uncomfortable sweating of the nasal surface.

### EXAMPLES

### Example 1

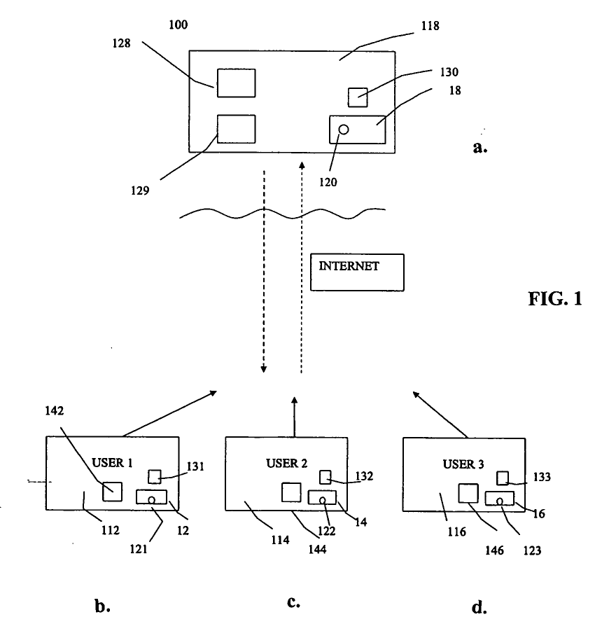

FIG. 1 and the following discussion provide a brief, general description of a suitable computing environment in which embodiments of the invention can be implemented. Although not required, embodiments of the invention will be described in the general context of computer-executable instructions, such as program application modules, objects, or macros being executed by a computer. Those skilled in the relevant art will appreciate that the invention can be practiced with other computer system configurations, including hand-held devices, multiprocessor systems, microprocessor-based or programmable consumer electronics, personal computers (“PCs”), network PCs, mini computers, mainframe computers, and the like. The invention can be practiced in distributed computing environments where tasks or modules are performed by remote processing devices, which are linked through a communications network. In a distributed computing environment, program modules may be located in both local and remote memory storage devices.

Referring to FIG. 1, a rapid customized mask design and manufacturing system 100 includes a client scanning/computing system 112, 114, and 116 and a host computing/mask producing system 118. The client scanning/computing system 12, 14, and 16 may be located at a diagnostic site, such as a hospital, clinic, laboratory or doctor's office. The host computing system 18 may be located at a site remote from the diagnostic site, such as at a site of a manufacturer. Client scanning/computer systems 112, 114, 116 each having a user computer unit 12, 14, 16 that interface with host computer unit 18 via a network connection 109. Each computer unit comprises at least one processing module 120, 121, 122, and 123, respectively, for processing information. Furthermore, each computer unit is communicatingly connected to a display 130 (optional), 131, 132, and 133. Communicatingly connected with each computer unit 12, 14, and 16 is a scanner 142, 144, and 146 for acquiring scanned images of patients target region of the face. The scanned images are processed by computer units 12, 14, and 16 and sent to host computer unit 18. The host computer unit processes image and directs the production of a mold via a CNC machine 128 based on the image data received from client 112, 114, and 116. Upon production of a mold, a mask is made via a vacuforming machine 129 that utilizes the mold made by the CNC 128 machine.

Alternatively, the client/scanning computers are not needed if the scanning and cutting take place in one location. In this alternative embodiment, a scanned image of a target region is obtained and then a CNC is directed to produce a mold as controlled by a single computer.

### Example 2

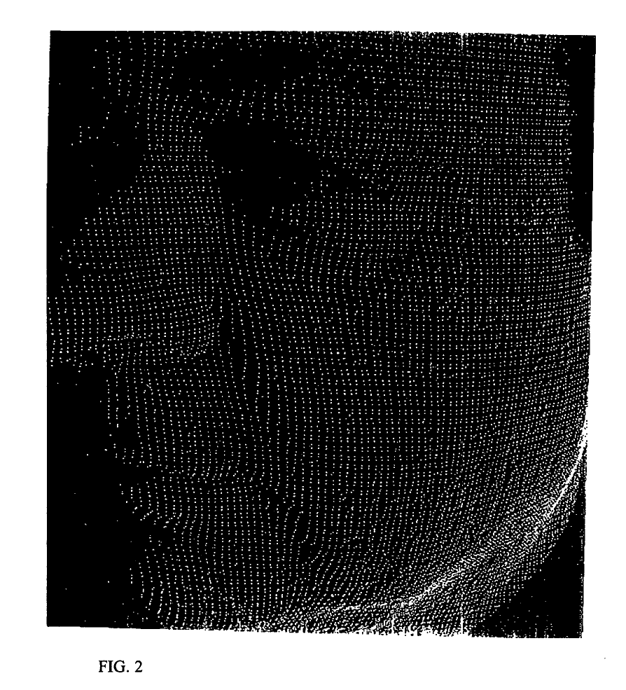

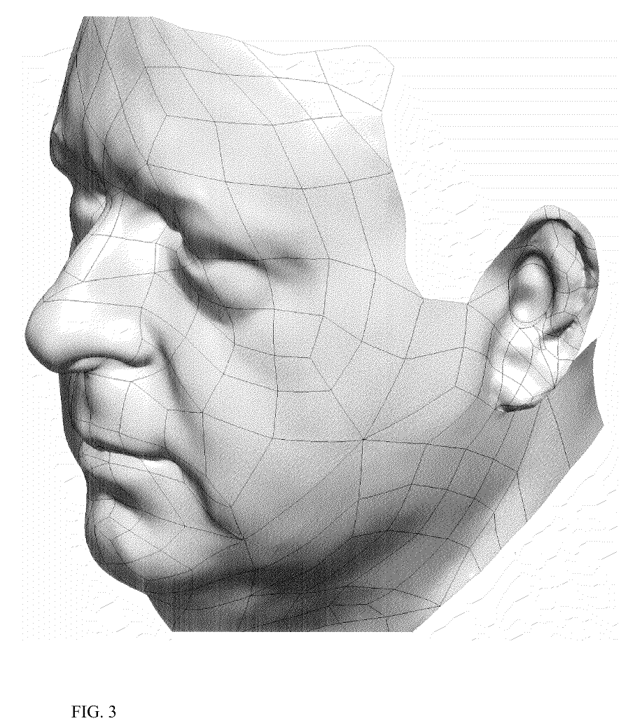

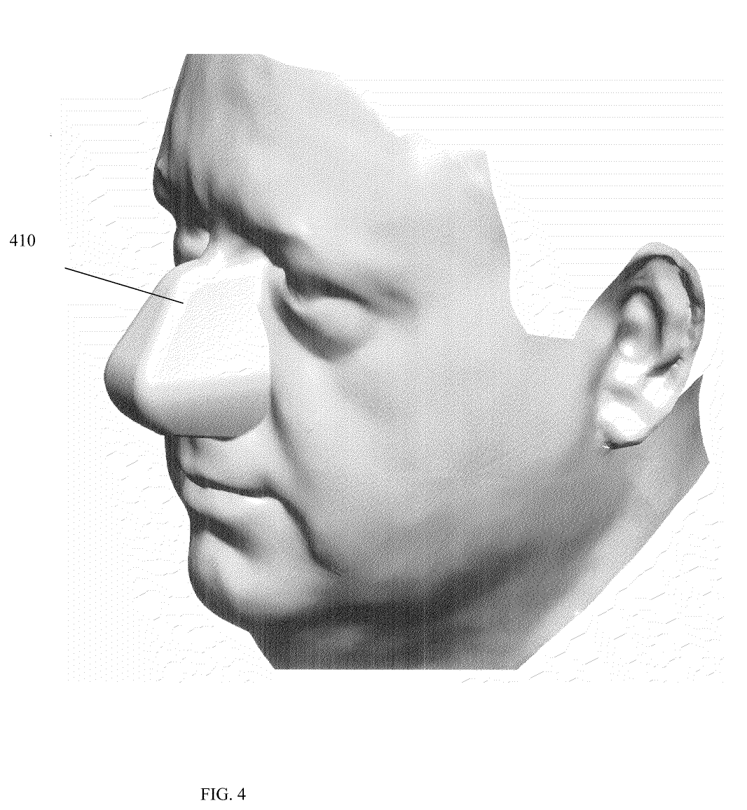

In a specific embodiment, the contour dataset from the scan(s) is used to form a stereolithography (STL) model image which is used by the CNC to form the mold according to known techniques. In a more specific embodiment, the contour dataset from the scan(s) relates to a point-cloud as shown in FIG. 2, which is used to form a stereolithography model image (FIGS. 3 & 4), which is used by the CNC to form the mold according to known techniques. Shown in FIG. 4 is the protrusion modification 410 to the image. This will direct production of the plenum during the mask forming process described below.

### Example 3

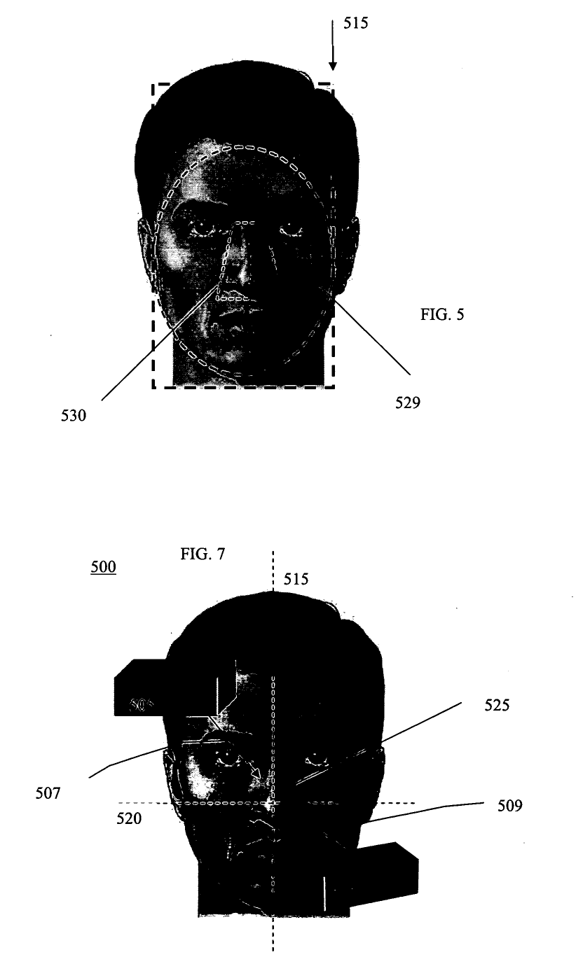

According to another embodiment, the invention pertains to a method of rapidly preparing a mask customized to a portion of a patient's face. The method entails the scanning of a patient's face contemporaneously from a first scanning angle and a second scanning angle. Referring to FIGS. 5 and 7, a specific method embodiment 500 is shown, wherein the first scanning head 505 scans at a first scanning angle 507 and second scanning head 510 scanning at a second scanning angle 509, wherein the scanning angles are oblique to a coronal plane 515 of a patient's head. As to the embodiment shown in FIG. 5, the first scanning angle 507 is at an angle above a horizontal plane 520 passing through the nose 525 of the patient, and the second angle 509 is at an angle below the horizontal plane 520. This specific embodiment 500 enables data to be obtained pertaining to the contours of a patient's target scan region 529 from both an upper and lower angle in one scanning step. The scans are integrated to provide a dataset corresponding to the contours of a target facial region, such as a nasal region 530. In turn, this allows for accurate contouring of regions under the nose that are not achieved by a single uniaxial scan direction. Though not shown, the scanning method preferably scans the target region while the patient is in a supine position. This is done to better reflect the affect of gravity on the features of the face, which in turn will make the mask more comfortable and form fitting to a sleeping patient. In an alternative embodiment, two separate scans are produced: one from an angle above a horizontal plane of a patient's face and another below the horizontal plane. These two scans are integrated to form a dataset corresponding to the contours of a patient's nasal region.

### Example 4

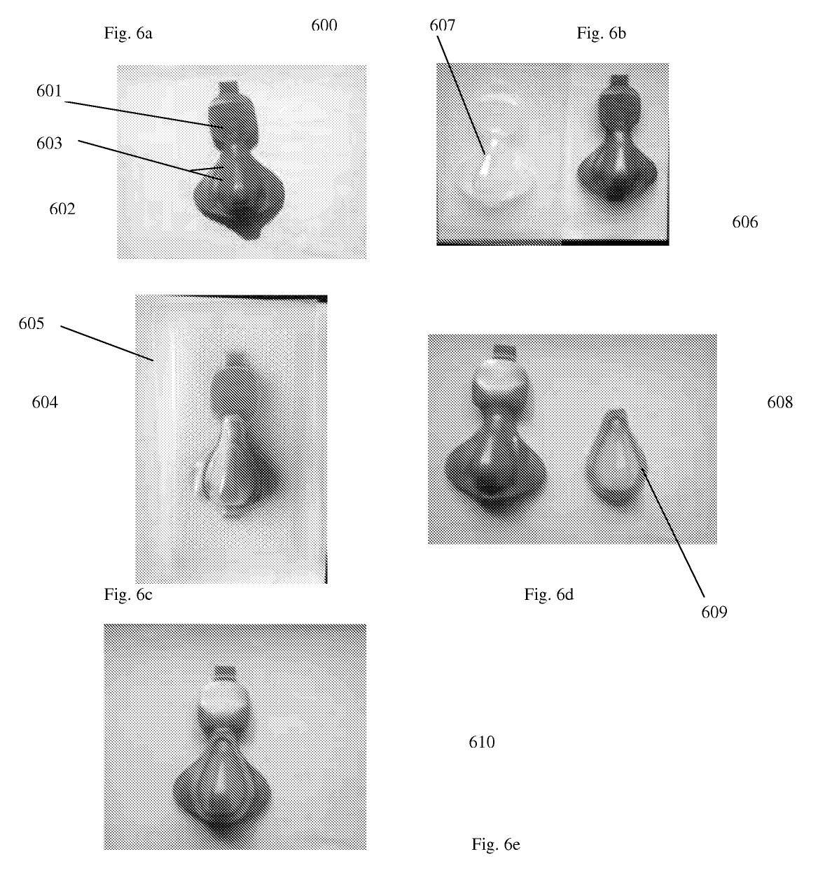

Turning to FIG. 6, a method 600 for manufacturing a mask is presented pictorially. In a first step (shown in 602), a mold 601 of target region of a patient's face is made. In this example, the mold 601 is made based on the stereolithography model shown in FIGS. 3 & 4. Thus, the mold 601 has a raised geometry 603 for creating the plenum as discussed above. Upon forming the mold 601, a thin layer of a plastic 605 (or other suitable material such as silicon) is placed over the mold and formed over the mold (shown in 604), such as by heating and vacuforming. The plastic material 605 is removed from the mold (shown in 606). The plastic layer 605 is cut to form a mask 607. A sealing material 609, of moderate durometer material such as silicon or rubber, is applied to the periphery of the cut mask (shown in 608). The sealing material 608 at the periphery of the mask 607 will contact with the patient's face (as shown in 610). The areas of the mask that do not come into contact with skin will include apertures and slots to accommodate connection of hoses for delivery of air and straps to secure the mask to the face As will be described further below, techniques other than vacuforming using a mold, such as stereolithography, may be used to form the mask.

As will be appreciated by one of skill in the art, embodiments of the present invention may be embodied as a device or system comprising a processing module, and/or computer program product comprising at least one program code module. Accordingly, the present invention may take the form of an entirely hardware embodiment or an embodiment combining software and hardware aspects. Furthermore, the present invention may include a computer program product on a computer-usable storage medium having computer-usable program code means embodied in the medium. Any suitable computer readable medium may be utilized including hard disks, CD-ROMs, DVDs, optical storage devices, or magnetic storage devices.

The term “processing module” may include a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The processing module may have operationally coupled thereto, or integrated therewith, a memory device. The memory device may be a single memory device or a plurality of memory devices. Such a memory device may be a read-only memory, random access memory, volatile memory, non-volatile memory, static memory, dynamic memory, flash memory, and/or any device that stores digital information. A computer, as used herein, is a device that comprises at least one processing module, and optionally at least one memory device.

The computer-usable or computer-readable medium may be or include, for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM), a CD ROM, a DVD (digital video disk), or other electronic storage medium. Note that the computer-usable or computer-readable medium could even be paper or another suitable medium upon which the program is printed, as the program can be electronically captured, via, for instance, optical scanning of the paper or other medium, then compiled, interpreted or otherwise processed in a suitable manner if necessary, and then stored in a computer memory.

Computer program code for carrying out operations of certain embodiments of the present invention may be written in an object oriented and/or conventional procedural programming languages including, but not limited to, Java, Smalltalk, Perl, Python, Ruby, Lisp, PHP, “C”, FORTRAN, or C++. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or a wireless network, or the connection may be made to an external computer (for example, through the Internet using an Internet Service Provider).

Certain embodiments of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer-readable program code modules. These program code modules may be provided to a processing module of a general purpose computer, special purpose computer, embedded processor or other programmable data processing apparatus to produce a machine, such that the program code modules, which execute via the processing module of the computer or other programmable data processing apparatus, create means for implementing the functions specified in the flowchart and/or block diagram block or blocks.

These computer program code modules may also be stored in a computer-readable memory that can direct a computer or other programmable data processing apparatus to function in a particular manner, such that the program code modules stored in the computer-readable memory produce an article of manufacture.

The computer program code modules may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart and/or block diagram block or blocks.

Encryption, password protection and digital certificate authentication is desirable in any such data transmission. Transmission of approval from the physician to the manufacturer can be stored with the file containing the agreed-upon design, forming a record of the same.

As discussed above, the customized masks may be constructed utilizing a mold and vacuforming process. However, masks may be constructed using new modified rapid prototyping techniques. Conventional three-dimensional printing (3DP) techniques, such as stereolithography, involve selectively bonding together powder in successively deposited layers to form generalized solid shapes. Rapid prototyping processes are detailed in U.S. Pat. Nos. 5,204,055, 5,387,380, 5,807,437, 5,340,656, 5,490,882, 5,814,161, 5,490,962, 5,518,680, and 5,869,170, all hereby incorporated by reference.

Since three-dimensional printing involves printing in layers, it requires instructions in which a multi-dimensional digital model is mathematically translated into a series of slices of narrow thickness, each slice having a set of data or printing instructions representing the part geometry at that particular plane. In three-dimensional printing, each slice corresponds to a layer of powder/liquid in the bed during construction of the model. The entire set of data or instructions is referred to as the machine instructions.

The present invention's use of an electronic design and manufacturing masks also permits additional advantages such as compilation of databases or profiles for individual physicians and/or hospitals or for individual patients, inventory control, record-keeping and billing, product design updates and client feedback, branding for selected distributions, and follow-up notices to users. Such information can be maintained on a secure Web site, available to appropriate categories of users such as through the use of passwords or similar access restrictions.

In some instances, the present invention may be used in a way which does not involve constructing masks to order, but rather involves selecting the best fit from a stock of already-manufactured components or designs. While selection from stock does not provide all of the advantages of manufacturing completely customized parts to order, it nevertheless would provide some degree of customization that might be adequate for certain purposes. It also would be even faster than fully customized manufacture. In this sort of application, scan data pertaining to a specific patient could still be employed, and could assist in deciding which stock item should be used. The selected stock items are shipped to the physician. This could executed by a central website would have further usefulness in that it could be used for maintaining records of inventory, records of rates of use, patterns of deterioration for subsequent product improvement design adjustments, and could indicate the need for replenishing items which are out of stock or nearly out of stock. Of course, similarly, for custom manufacturing, the website could still help to maintain inventories of predict usage patterns and inventories of raw materials.

### Rapid Prototyping Techniques

Most commercially available rapid prototyping machines use one of six techniques: stereolithography, laminated object manufacturing, selective laser sintering, fused deposition modeling, solid ground curing, and 3-D ink-jet printing. The different rapid prototyping techniques have their unique individual strengths. Because RP technologies are being increasingly used in non-prototyping, even production, applications, the techniques are often collectively referred to as solid free-form fabrication, computer automated manufacturing, or layered manufacturing. The latter term is particularly descriptive of the manufacturing process used by all commercial techniques. A software package “slices” the CAD model into a number of thin (˜0.1 mm) layers, which are then built up one atop another. Rapid prototyping is an “additive” process, conventionally combining layers of paper, wax, or plastic to create a solid object. In contrast, most machining processes (milling, drilling, grinding, etc.) are “subtractive” processes that remove material from a solid block. RP's additive nature allows it to create objects with complicated internal features that cannot be manufactured by other means. Below is a brief and general description of 6 rapid prototyping techniques. More description can be found at http://www.me.psu.edu/lamancusa/rapidpro/primer/chapter2.htm, and also described in U.S. Pat. Nos. 4,961,154, 5,198,159, 5,897,825, 6,508,971, and 6,790,403, the teachings of which are incorporated herein in their entirety to the extent not inconsistent with the teachings herein.

### Stereolithography

The technique builds three-dimensional objects (in this case masks or molds) from liquid photosensitive polymers that solidify when exposed to ultraviolet light. According to this technique, the model is conventionally built upon a platform situated just below the surface in a vat of liquid epoxy or acrylate resin. A low-power highly focused UV laser traces out the first layer, solidifying the object's cross section while leaving excess areas liquid. Next, an elevator incrementally lowers the platform into the liquid polymer. A sweeper re-coats the solidified layer with liquid, and the laser traces the second layer atop the first. This process is repeated until the prototype is complete. Afterwards, the solid part is removed from the vat and rinsed clean of excess liquid. Supports are broken off and the model is then placed in an ultraviolet oven for complete curing.

### Laminated Object Manufacturing

In this technique, layers of adhesive-coated sheet material are bonded together to form a prototype. The original material consists of paper laminated with heat-activated glue and rolled up on spools. A feeder/collector mechanism advances the sheet over the build platform, where a base has been constructed from paper and double-sided foam tape. Next, a heated roller applies pressure to bond the paper to the base. A focused laser cuts the outline of the first layer into the paper and then cross-hatches the excess area (the negative space in the prototype). Cross-hatching breaks up the extra material, making it easier to remove during post-processing. During the build, the excess material provides excellent support for overhangs and thin-walled sections. After the first layer is cut, the platform lowers out of the way and fresh material is advanced. The platform rises to slightly below the previous height, the roller bonds the second layer to the first, and the laser cuts the second layer. This process is repeated as needed to build the part, which will have a wood-like texture.

### Selective Laser Sintering

The technique uses a laser beam to selectively fuse powdered materials, such as nylon, elastomer, and metal, into a solid object. Parts are built upon a platform which sits just below the surface in a bin of the heat-fusable powder. A laser traces the pattern of the first layer, sintering it together. The platform is lowered by the height of the next layer and powder is reapplied. This process continues until the part is complete. Excess powder in each layer helps to support the part during the build. SLS machines are produced by DTM of Austin, Tex.

### Fused Deposition Modeling

In this technique, filaments of heated thermoplastic are extruded from a tip that moves in the x-y plane. Like a baker decorating a cake, the controlled extrusion head deposits very thin beads of material onto the build platform to form the first layer. The platform is maintained at a lower temperature, so that the thermoplastic quickly hardens. After the platform lowers, the extrusion head deposits a second layer upon the first. Supports are built along the way, fastened to the part either with a second, weaker material or with a perforated junction. Stratasys, of Eden Prairie, Minn. makes a variety of FDM machines ranging from fast concept modelers to slower, high-precision machines. Materials conventionally include ABS (standard and medical grade), elastomer (96 durometer), polycarbonate, polyphenolsulfone, and investment casting wax.

### Solid Ground Curing

Solid ground curing (SGC) is somewhat similar to stereolithography (SLA) in that both use ultraviolet light to selectively harden photosensitive polymers. Unlike SLA, SGC cures an entire layer at a time. First, photosensitive resin is sprayed on the build platform. Next, the machine develops a photomask (like a stencil) of the layer to be built. This photomask is printed on a glass plate above the build platform using an electrostatic process similar to that found in photocopiers. The photomask is then exposed to UV light, which only passes through the transparent portions of the photomask to selectively harden the shape of the current layer. After the layer is cured, the machine vacuums up the excess liquid resin and sprays wax in its place to support the model during the build. The top surface is milled flat, and then the process repeats to build the next layer. When the part is complete, it must be de-waxed by immersing it in a solvent bath. SGC machines are distributed in the U.S. by Cubital America Inc. of Troy, Mich.

### 3-D Ink-Jet Printing

Ink-Jet Printing refers to an entire class of machines that employ ink-jet technology. The first was 3D Printing (3DP), developed at MIT and licensed to Soligen Corporation, Extrude Hone, and others. The ZCorp 3D printer, produced by Z Corporation of Burlington, Mass. (www.zcorp.com) is an example of this technology. Parts are built upon a platform situated in a bin full of powder material. An ink-jet printing head selectively deposits or “prints” a binder fluid to fuse the powder together in the desired areas. Unbound powder remains to support the part. The platform is lowered, more powder added and leveled, and the process repeated. When finished, the fused part is then removed from the unbound powder, and excess unbound powder is blown off. Finished parts can be infiltrated with wax, glue, or other sealants to improve durability and surface finish. Typical layer thicknesses are on the order of 0.1 mm.

3D Systems' (www.3dsystems.com) version of the ink-jet based system is called the Thermo-Jet or Multi-Jet Printer. It uses a linear array of print heads to rapidly produce thermoplastic models. If the part is narrow enough, the print head can deposit an entire layer in one pass. Otherwise, the head makes several passes.

As alluded to above, in view of the teachings herein, the above rapid production techniques could be adapted to produce either masks or molds based on scanned images of a target region of a patient's face.

Finally, while various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims. The teachings of all patents and other references cited herein are incorporated herein by reference to the extent they are not inconsistent with the teachings herein.

What is claimed is:

1. A system for rapidly designing a mask used in conjunction with CPAP that is anatomically customized to a particular region of a patient's face, said system comprising:
a scanner for producing a multidimensional image, said scanner having at least two scanning heads configured at different angles respective to said patient's face, each scanning head producing a first and second image dataset, respectively;
a first computer communicatingly connected to said scanner and, optionally, a second computer communicatingly connected to said first computer; said first computer comprising a processing module and said optional second computer comprising a processing module, and at least two computer program code modules stored on one or the other of said first and optional second computers, or both: a first computer program code module for integrating said first and second image datasets into a master dataset; a second computer program code module for producing a multidimensional model image from said master dataset; a third computer program code module for directing a CNC machine to produce a mold of said patient's face based on said multidimensional model image.

2. The system of claim 1, wherein said multidimensional model image is a stereolithography model image.

3. The system of claim 1, wherein said first and/or second scanning heads are laser line scanners.

4. The system of claim 1, wherein said master dataset is a points cloud derived from said first and second datasets.

5. The system of claim 1, wherein the first and second scanning angles are oblique to a coronal plane said patient's head.

6. The system of claim 5, wherein said first scanning angle is at an angle above a horizontal plane passing through a nose of said patient, and said second angle is at an angle below said horizontal plane.

7. The system of claim 1, wherein said multidimensional image is adjusted by raising a geometry to form a protruded surface that extends from a natural contour of at least a portion of said multidimensional image.

8. The system of claim 7, wherein said protruded surface extends between 0.1 to 1.0 inches from a natural contour of said portion.

9. The system of claim 8, wherein said protruded surface extends between 0.15 to 0.4 inches from a natural contour of said portion.

10. A method for rapidly producing a mask used in conjunction with CPAP that is anatomically customized to a particular region of a patient's face, said method comprising:
scanning said patient's face at a first scanning angle to produce a first dataset;
scanning said patient's face at a second scanning angle to produce a second dataset; wherein said first and second datasets are produced simultaneously;
generating a master dataset based on said first and second datasets;
converting said master dataset into multidimensional model image useful in directing a cutting machine;
cutting a mold of said patient's face based on said multidimensional model image; and
vacuforming a layer of material over said mold to form an unfinished mask;

11. The method of claim 10, further comprising attaching a seal to a perimeter of said unfinished mask to form a finished mask.

12. The method of claim 10, further comprising forming apertures in said mask for application of gas to said mask.

13. The method of claim 10, wherein said first scanning angle is at an angle above a horizontal plane passing through a nose of said patient, and said second angle is at an angle below said horizontal plane.

14. The method of claim 10, wherein said first and second datasets, said master dataset or said multidimensional image is transmitted from a first computer to a second computer via a LAN network or a WAN network.

15. The method of claim 14, wherein said WAN network is the internet.

16. The method of claim 10, further comprising generating a protruding surface to be present on said multidimensional image, wherein said protruding surface extends from a natural contour of at least a portion of said multidimensional image.

17. A mask anatomically customized to a patient's face, said mask made by the method of claim 10.

18. The mask of claim 17, wherein said mask weighs between 15 to 45 grams, and is comprised of a thin layer of material, said layer being between 3/32 inches to ⅛ inches in thickness.

19. The mask of claim 17, wherein said mask is configured to only touch the nose of said patient at the nasal bridge and closely follows the contours of the nasal bridge such that when pressure is applied to either a left side or a right side of said mask, said mask does not lift off the nasal bridge.

20. The mask of claim 17, wherein said mask forms a plenum over the nose of said patient, wherein said plenum defines a space of between 0.1 to 1.0 inches off the nose.

21. The system of claim 1, wherein said first and second computers are communicatingly connected via the internet.
